(19) United States
(12) Patent Application Publication
(10) Pub. No.: US 2023/0263253 A1
(43) Pub. Date: Aug. 24, 2023

(54) FIBERS FOR ARTIFICIAL HAIR AND HEADDRESS PRODUCT

(71) Applicant: Denka Company Limited, (US)

(72) Inventors: Sho HAKAMADA, Chuo-ku, Tokyo (JP); Atsushi TAKEI, Chuo-ku, Tokyo (JP); Takashi MURAOKA, Chuo-ku, Tokyo (JP)

(73) Assignee: Denka Company Limited, Chuo-ku, Tokyo (JP)

(21) Appl. No.: 17/768,949

(22) PCT Filed: Oct. 27, 2020
(86) PCT No.: PCT/JP2020/040300

§ 371 Date: Apr. 14, 2022

(30) Foreign Application Priority Data
Nov. 7, 2019 (JP) 2019-202026
Jul. 28, 2020 (JP) 2020-127218

(51) Int. Cl. A41G 3/00; C08L 77/06; A41G 5/00; D01F 6/60; D01F 1/02; D01F 6/74; D01F 6/42

(52) U.S. Cl. CPC A41G 3/0083; C08L 77/06; A41G 5/0093; D01F 6/60; D01F 1/02; D01F 6/74; D01F 6/42; C08L 2312/00; C08L 2203/12; D10B 2503/08

(57) ABSTRACT

Disclosed is a fiber for artificial hair containing a polycondensation-based polymer and a crosslinking agent. Also disclosed is a headdress article including the fiber for artificial hair.

### TECHNICAL FIELD

The present invention relates to a fiber for artificial hair, a headdress article, and the like.

### BACKGROUND ART

Fibers for artificial hair (fibers used for artificial hair) can be used for hairpieces, hair wigs, false hair, and the like, all of which are wearable on and removable from the head portion. In the following Patent Literature 1, a fiber for artificial hair obtained by fiberizing a resin composition containing a polyamide-based resin and a bromine-based flame retardant is disclosed.

### CITATION LIST

### Patent Literature

Patent Literature 1: Japanese Unexamined Patent Publication No. 2011-246844

### SUMMARY OF INVENTION

### Technical Problem

In the above-described Patent Literature 1, a fiber for artificial hair is produced by stretching unstretched fiber formed by melt-spinning. At this time, there are occasions in which the fiber is not uniformly stretched at the time of stretching, and bump-like nodes are formed in the fiber after stretching. When nodes are present in a fiber for artificial hair, there is a problem that the tactile sensation is deteriorated.

An object of an aspect of the present invention is to provide a fiber for artificial hair with fewer nodes. An object of another aspect of the present invention is to provide a headdress article including such a fiber for artificial hair.

### Solution to Problem

An aspect of the present invention relates to a fiber for artificial hair, the fiber containing a polycondensation-based polymer and a crosslinking agent.

Another aspect of the present invention relates to a headdress article including the above-mentioned fiber for artificial hair.

### Advantageous Effects of Invention

According to an aspect of the present invention, a fiber for artificial hair with fewer nodes can be provided. According to another aspect of the present invention, a headdress article including such a fiber for artificial hair can be provided.

### DESCRIPTION OF EMBODIMENTS

Hereinafter, embodiments of the present invention will be described in detail.

The expression “A or more” of a numerical value range means A and a range of more than A. The expression “A or less” of a numerical value range means A and a range of less than A. With regard to a numerical value range described stepwise in the present specification, the upper limit value or the lower limit value of the numerical value range at a certain stage can be optionally combined with the upper limit value or the lower limit value of the numerical value range of another stage. With respect to a numerical value range described in the present specification, the upper limit value or the lower limit value of the numerical value range may be substituted with the values shown in the Examples. The expression “A or B” may include either A or B or may include both of them. Unless particularly stated otherwise, the materials described as examples in the present specification can be used singly or in combination of two or more kinds thereof. In a case where a plurality of substances corresponding to each component in a composition is present, unless particularly stated otherwise, the content of each component in the composition means the total amount of the plurality of substances present in the composition. The term “step” means not only an independent step, but even in a case where a step cannot be clearly distinguished from another step, the step is included in the present term as long as the predetermined action of the step is achieved. The term “(meth)acrylic” means at least one of acrylic and methacrylic corresponding thereto. The same also applies to other similar expressions such as “(meth)acrylic acid”.

The fiber for artificial hair of the present embodiment contains a polycondensation-based polymer and a crosslinking agent. The fiber for artificial hair of the present embodiment can be used as artificial hair and can also be used in order to obtain artificial hair.

The inventors of the present invention conducted a thorough investigation, and found that a fiber for artificial hair in which the generation of nodes is suppressed is obtained by fiberizing a resin composition containing a polycondensation-based polymer and a crosslinking agent (for example, a resin composition containing a base resin including a polycondensation-based polymer and a crosslinking agent). The fiber for artificial hair of the present embodiment is a fiber for artificial hair with fewer nodes when subjected to a stretching treatment. It is speculated that, in the fiber for artificial hair of the present embodiment, the generation of nodes is suppressed as entanglement of the molecular chains is enhanced by crosslinking of the polycondensation-based polymer and the crosslinking agent. However, the factor of having fewer nodes is not limited to this factor.

Incidentally, conventional fibers for artificial hair have excessively high luster as compared with human hair, and therefore, there is a problem that the conventional fibers for artificial hair are easily recognizable as artificial hair. Therefore, fibers for artificial hair may be required to have less luster. The fiber for artificial hair of the present embodiment may be a fiber for artificial hair with less luster. It is speculated that, in the fiber for artificial hair of the present embodiment, luster is reduced by suitably forming surface unevenness (surface unevenness to the extent that does not form bumps) on the surface of the fiber by using the polycondensation-based polymer and the crosslinking agent in combination. However, the factor of having less luster is not limited to this factor. In the fiber for artificial hair of the present embodiment, since luster is not likely to be generated, it is easy to maintain a semi-lustrous state to a 70% lustrous state.

The fiber for artificial hair of the present embodiment may be a resin composition containing the polycondensation-based polymer and the crosslinking agent. The resin composition may contain a base resin including the polycondensation-based polymer and the crosslinking agent or may be obtained by melt-kneading a mixture containing the polycondensation-based polymer and the crosslinking agent. The fiber for artificial hair of the present embodiment may be formed by a fiber composed of a resin composition containing the polycondensation-based polymer and the crosslinking agent or may be formed by a fiber in which a resin composition containing the polycondensation-based polymer and the crosslinking agent is melt-deformed. The fiber for artificial hair of the present embodiment may be a fiber after a stretching treatment (fiber for artificial hair formed by a fiber obtained by stretching of a resin composition) or may be an unstretched fiber (unstretched fiber). The fiber for artificial hair of the present embodiment may be an unstretched fiber obtainable by spinning a resin composition containing the polycondensation-based polymer and the crosslinking agent or may be a fiber obtainable by stretching this unstretched fiber. Regarding each of the polycondensation-based polymer and the crosslinking agent, one kind thereof can be used singly, or two or more kinds thereof can be used in combination.

The single fiber fineness of the fiber for artificial hair of the present embodiment is preferably in the following range after a stretching treatment. The single fiber fineness is preferably 20 decitex or more, and more preferably 35 decitex or more. The single fiber fineness is preferably 100 decitex or less, and more preferably 80 decitex or less. From these viewpoints, the single fiber fineness is preferably 20 to 100 decitex, and more preferably 35 to 80 decitex.

From the viewpoint that the stretch ratio can be made small in order to obtain a fiber for artificial hair with a finer fiber degree, and that luster is less likely to be generated in the fiber for artificial hair after a stretching treatment, the single fiber fineness of the fiber for artificial hair of the present embodiment at the time of being unstretched is preferably 300 decitex or less, and more preferably 200 decitex or less.

Examples of the polycondensation-based polymer include a polyamide-based resin (polyamide) and a polyester. The fiber for artificial hair of the present embodiment may not contain a polyester. From the viewpoint that nodes are easily reduced, and from the viewpoint that luster is easily reduced, it is preferable that the polycondensation-based polymer includes a polyamide-based resin.

The polyamide-based resin may be, for example, a polyamide such as an aliphatic polyamide; an aromatic polyamide; or a semi-aromatic polyamide having a skeleton that is obtainable by a polycondensation reaction between an aliphatic diamine and an aromatic dicarboxylic acid. Examples of the aliphatic polyamide include polyamide 6 (nylon 6), polyamide 66 (nylon 66), polyamide 12 (nylon 12), polyamide 6/66 (nylon 6/66), and polyamide 6/12 (nylon 6/12). Examples of the aromatic polyamide include polymetaxylylene-adipamide (nylon MXD6). Examples of the semi-aromatic polyamide include polyamide 6T (nylon 6T), polyamide 9T (nylon 9T), and polyamide 10T (nylon 10T).

Examples of the polyester include polyethylene terephthalate, polypropylene terephthalate, polybutylene terephthalate, and polycyclohexane dimethylene terephthalate.

It is preferable that the content of the polycondensation-based polymer is in the following range based on the total mass of the fiber for artificial hair. From the viewpoint that nodes and luster are easily reduced in a well-balanced manner, the content of the polycondensation-based polymer is preferably 10% by mass or more, 20% by mass or more, 30% by mass or more, 40% by mass or more, 50% by mass or more, more than 50% by mass, 60% by mass or more, 65% by mass or more, 67% by mass or more, 68% by mass or more, or 69% by mass or more. From the viewpoint that nodes and luster are easily reduced in a well-balanced manner, the content of the polycondensation-based polymer is preferably 95% by mass or less, 90% by mass or less, 80% by mass or less, 75% by mass or less, 74% by mass or less, 73% by mass or less, 72% by mass or less, 71% by mass or less, or 70% by mass or less. From these viewpoints, the content of the polycondensation-based polymer is preferably 10% to 95% by mass, 50% to 90% by mass, or 60% to 90% by mass. The content of the polycondensation-based polymer may be 70% by mass or more, 71% by mass or more, 72% by mass or more, 73% by mass or more, or 74% by mass or more. The content of the polycondensation-based polymer may be 69% by mass or less or 68% by mass or less. From a similar viewpoint, it is preferable that the content of the polyamide-based resin is in each of these ranges based on the total mass of the fiber for artificial hair.

As the crosslinking agent, a compound capable of reacting with a terminal functional group (for example, an amino group) of the polycondensation-based polymer can be used. The crosslinking agent has a functional group that contributes to crosslinking. Examples of such a functional group include a carboxyl group and a maleic anhydride group. As the crosslinking agent, a compound that does not correspond to the polycondensation-based polymer can be used.

The crosslinking agent may have various monomers as monomer units (monomer unit=structural unit; hereinafter, the same) and can have monomer units derived from various monomers. Examples of such a monomer include an aromatic vinyl compound, a maleimide compound (compound having a maleimide group), a maleic acid compound, an olefin-based hydrocarbon (ethylene, propylene, butylene, or the like), a (meth)acrylic acid ester (methyl (meth)acrylate, ethyl (meth)acrylate, butyl (meth)acrylate, or the like), an unsaturated dicarboxylic acid (itaconic acid, citraconic acid, aconitic acid, or the like), an unsaturated dicarboxylic acid anhydride (itaconic anhydride, citraconic anhydride, aconitic anhydride, or the like; maleic anhydride (anhydrous maleic acid) is excluded), vinyl acetate, vinylcarboxylic acid ((meth)acrylic acid or the like), and (meth)acrylic acid amide. The monomers can be used singly or in combination of two or more kinds thereof.

From the viewpoint that nodes are easily reduced, from the viewpoint that luster is easily reduced, and from the viewpoint that the hue of the crosslinking agent and the fiber for artificial hair is easily enhanced (yellow tinge is easily suppressed), it is preferable that the crosslinking agent has an aromatic vinyl compound as a monomer unit, and it is also preferable that the crosslinking agent has a monomer unit derived from an aromatic vinyl compound.

Examples of the aromatic vinyl compound include styrene-based compounds such as styrene, o-methylstyrene, m-methylstyrene, p-methyl styrene, 2,4-dimethylstyrene, ethylstyrene, p-tert-butylstyrene, α-methylstyrene, and α-methyl-p-methylstyrene. From the viewpoint that nodes are more easily reduced, from the viewpoint that luster is more easily reduced, and from the viewpoint that the effect of enhancing the hue of the crosslinking agent and the fiber for artificial hair is higher, it is preferable that the aromatic vinyl compound includes styrene. The aromatic vinyl compounds (styrene-based compound or the like) can be used singly or in combination of two or more kinds thereof.

Examples of the maleimide compound include maleimide; N-alkylmaleimides such as N-methylmaleimide, N-butylmaleimide, and N-cyclohexylmaleimide; and aromatic maleimides such as N-phenylmaleimide, N-chlorophenylmaleimide, N-methylphenyl maleimide, N-methoxyphenylmaleimide, and N-tribromophenylmaleimide. From the viewpoint that nodes are easily reduced, from the viewpoint that luster is easily reduced, and from the viewpoint that the effect of enhancing heat resistance of the crosslinking agent and the fiber for artificial hair is high, it is preferable that the maleimide compound includes at least one selected from the group consisting of maleimide and N-phenylmaleimide. The maleimide compounds can be used singly or in combination of two or more kinds thereof.

Examples of the maleic acid compound include maleic acid and a maleic acid derivative. Examples of the maleic acid derivative include maleic anhydride, a maleic acid salt (for example, sodium maleate), and a maleic acid ester (for example, a maleic acid alkyl ester such as methyl maleate). From the viewpoint that nodes are easily reduced, and from the viewpoint that luster is easily reduced, it is preferable that the maleic acid compound includes maleic anhydride.

Examples of the crosslinking agent include a maleimide-based polymer (maleimide-based polymer), an epoxy-modified polymer (excluding a compound corresponding to the maleimide-based polymer), and a maleic acid-based polymer (excluding a compound corresponding to the epoxy-modified polymer or the maleimide-based polymer). The crosslinking agent may be an embodiment including a maleimide-based polymer, may be an embodiment including an epoxy-modified polymer, and may be an embodiment including a maleic acid-based polymer. Regarding each of the maleimide-based polymer, the epoxy-modified polymer, and the maleic acid-based polymer, one kind thereof can be used singly, or two or more kinds thereof can be used in combination.

From the viewpoint that nodes are easily reduced, and from the viewpoint that luster is easily reduced, it is preferable that the crosslinking agent includes at least one selected from the group consisting of a maleimide-based polymer, an epoxy-modified polymer, and a maleic acid-based polymer, and from the viewpoint that luster is more easily reduced, it is preferable that the crosslinking agent includes at least one selected from the group consisting of a maleimide-based polymer and a maleic acid-based polymer; and it is even more preferable that the crosslinking agent includes a maleimide-based polymer.

The maleimide-based polymer has a maleimide compound as a monomer unit (maleimide monomer unit) and can have a monomer unit derived from a maleimide compound. By using a maleimide-based polymer, the heat resistance of the fiber for artificial hair is easily enhanced. The monomer unit of the maleimide compound may be obtained by polymerizing a raw material including a maleimide compound or may be obtained by polymerizing an unsaturated dicarboxylic acid anhydride and then reacting a group derived from the unsaturated dicarboxylic acid anhydride with ammonia or a primary amine to convert the group derived from the unsaturated dicarboxylic acid anhydride (post-imidization method). As the maleimide-based polymer, a maleimide-based homopolymer (homopolymer of a maleimide compound) or a maleimide-based copolymer (copolymer of a maleimide compound) can be used.

It is preferable that the content of the monomer unit of the maleimide compound in the maleimide-based polymer is in the following range based on the total mass of the maleimide-based polymer. From the viewpoint that it is easy to promote enhancement of the heat resistance of the maleimide-based polymer and the fiber for artificial hair, the content of the monomer unit of the maleimide compound is preferably 35% by mass or more, and more preferably 37% by mass or more. From the viewpoint that satisfactory impact strength of the maleimide-based polymer and the fiber for artificial hair is easily obtained, the content of the monomer unit of the maleimide compound is preferably 50% by mass or less, and more preferably 45% by mass or less. From these viewpoints, the content of the monomer unit of the maleimide compound is preferably 35% to 50% by mass, and more preferably 37% to 45% by mass.

The maleimide-based copolymer has a compound different from the maleimide compound as a monomer unit. The maleimide-based copolymer may be obtained by copolymerizing a raw material including a maleimide compound and a monomer other than a maleimide compound or may be obtained by copolymerizing an unsaturated dicarboxylic acid anhydride and then reacting a group derived from the unsaturated dicarboxylic acid anhydride with ammonia or a primary amine to convert the group derived from the unsaturated dicarboxylic acid anhydride (post-imidization method). As the compound different from the maleimide compound, various monomers mentioned above in relation to the crosslinking agent can be used.

From the viewpoint that nodes are easily reduced, from the viewpoint that luster is easily reduced, and from the viewpoint that the hue of the maleimide-based copolymer and the fiber for artificial hair is easily enhanced (yellow tinge is easily suppressed), it is preferable that the maleimide-based copolymer has an aromatic vinyl compound as a monomer unit, and it is also preferable that the maleimide-based copolymer has a monomer unit derived from an aromatic vinyl compound. As the aromatic vinyl compound, the above-mentioned styrene-based compound and the like in relation to the crosslinking agent can be used. From the viewpoint that nodes are more easily reduced, from the viewpoint that luster is more easily reduced, and from the viewpoint that the effect of enhancing the hue of the maleimide-based copolymer and the fiber for artificial hair is higher, it is preferable that the aromatic vinyl compound includes styrene.

It is preferable that the content of the monomer unit of the aromatic vinyl compound in the maleimide-based copolymer is in the following range based on the total mass of the maleimide-based copolymer. From the viewpoint that satisfactory hue of the maleimide-based copolymer and the fiber for artificial hair is easily obtained, the content of the monomer unit of the aromatic vinyl compound is preferably 40% by mass or more, and more preferably 45% by mass or more. From the viewpoint that satisfactory heat resistance of the maleimide-based copolymer and the fiber for artificial hair is easily obtained, the content of the monomer unit of the aromatic vinyl compound is preferably 60% by mass or less, and more preferably 55% by mass or less. From these viewpoints, the content of the monomer unit of the aromatic vinyl compound is preferably 40% to 60% by mass, and more preferably 45% to 55% by mass.

It is preferable that the maleimide-based copolymer has an unsaturated dicarboxylic acid anhydride as a monomer unit, and it is preferable that the maleimide-based copolymer has a monomer unit derived from an unsaturated dicarboxylic acid anhydride. In this case, the monomer unit of an unsaturated dicarboxylic acid anhydride reacts with another polymer having a terminal of an amino group or alcohol group, and an effect as a compatibilizing agent for this polymer is easily obtained.

It is preferable that the content of the monomer unit of an unsaturated dicarboxylic acid anhydride in the maleimide-based polymer is in the following range based on the total mass of the maleimide-based polymer. From the viewpoint that nodes and luster are easily reduced in a well-balanced manner, and from the viewpoint that the monomer unit of an unsaturated dicarboxylic acid anhydride reacts with another polymer having a terminal of an amino group or alcohol group, and an effect as a compatibilizing agent for this polymer is more easily obtained, the content of the monomer unit of the unsaturated dicarboxylic acid anhydride is preferably 0.1% by mass or more, 0.3% by mass or more, 0.5% by mass or more, 0.8% by mass or more, 1% by mass or more, 1.2% by mass or more, 1.5% by mass or more, 2% by mass or more, 3% by mass or more, 5% by mass or more, or 6% by mass or more. From the viewpoint that nodes and luster are easily reduced in a well-balanced manner, and from the viewpoint that excellent thermal stability is easily obtained, the content of the monomer unit of the unsaturated dicarboxylic acid anhydride is preferably 10% by mass or less, 8% by mass or less, or 6% by mass or less. From these viewpoints, the content of the monomer unit of the unsaturated dicarboxylic acid anhydride is preferably 0.1% to 10% by mass, 0.5% to 10% by mass, or 0.5% to 6% by mass. The content of the monomer unit of the unsaturated dicarboxylic acid anhydride may be 5% by mass or less, 3% by mass or less, 2% by mass or less, or 1.5% by mass or less. The content of the monomer unit of the unsaturated dicarboxylic acid anhydride may be 0.5% to 5% by mass.

Specific examples of the maleimide-based polymer include a styrene-maleimide copolymer, a maleimide-maleic anhydride copolymer, and a styrene-maleimide-maleic anhydride copolymer. From the viewpoint that nodes are easily reduced, and from the viewpoint that luster is easily reduced, it is preferable that the maleimide-based polymer includes a styrene-maleimide-maleic anhydride copolymer.

When the crosslinking agent includes a maleimide-based polymer, the content of the maleimide-based polymer is preferably 80% by mass or more, 90% by mass or more, 95% by mass or more, 98% by mass or more, or 99% by mass or more, based on the total mass of the crosslinking agent (the total mass of the crosslinking agent included in the fiber for artificial hair; hereinafter, the same). An embodiment in which the crosslinking agent is substantially composed of a maleimide-based polymer (substantially 100% by mass of the crosslinking agent is a maleimide-based polymer) is also acceptable.

Examples of the epoxy-modified polymer include an epoxy-modified (meth)acrylic polymer, which is a polymer having an epoxy group at a terminal and/or in a side chain of the main chain of a (meth)acrylic polymer, and an epoxy-modified polyolefin, which is a polymer having an epoxy group at a terminal and/or in a side chain of the main chain of a polyolefin. Regarding the epoxy-modified polymer, one kind thereof can be used singly, or two or more kinds thereof can be used in combination.

The epoxy-modified (meth)acrylic polymer has a (meth)acryloyl group. The epoxy-modified polyolefin has an olefin-based hydrocarbon as a monomer unit and can have a monomer unit derived from an olefin-based hydrocarbon.

From the viewpoint that nodes are easily reduced, from the viewpoint that luster is easily reduced, and from the viewpoint that the hue of the epoxy-modified polymer and the fiber for artificial hair is easily enhanced (yellow tinge is easily suppressed), it is preferable that the epoxy-modified polymer has an aromatic vinyl compound as a monomer unit, and it is also preferable that the epoxy-modified polymer has a monomer unit derived from an aromatic vinyl compound. As the aromatic vinyl compound, a styrene-based compound and the like mentioned above in relation to the crosslinking agent can be used. From the viewpoint that nodes are more easily reduced, from the viewpoint that luster is more easily reduced, and from the viewpoint that an effect of enhancing the hue of the epoxy-modified polymer and the fiber for artificial hair is higher, it is preferable that the aromatic vinyl compound includes styrene.

When the crosslinking agent includes an epoxy-modified polymer, the content of the epoxy-modified polymer is preferably 80% by mass or more, 90% by mass or more, 95% by mass or more, 98% by mass or more, or 99% by mass or more, based on the total mass of the crosslinking agent. An embodiment in which the crosslinking agent is substantially composed of an epoxy-modified polymer (substantially 100% by mass of the crosslinking agent is an epoxy-modified polymer) is also acceptable.

The maleic acid-based polymer has at least one maleic acid compound selected from the group consisting of maleic acid and a maleic acid derivative as a monomer unit and can have a monomer unit derived from a maleic acid compound. As the maleic acid derivative, the maleic acid derivative mentioned above in relation to the crosslinking agent can be used. From the viewpoint that nodes and luster are easily reduced in a well-balanced manner, it is preferable that the maleic acid compound includes maleic anhydride (it is preferable that the maleic acid-based polymer is a maleic anhydride-modified polymer, which is a copolymer having a skeleton of maleic anhydride introduced into a molecule). From the viewpoint that nodes and luster are easily reduced in a well-balanced manner, it is preferable that the maleic acid-based polymer has a polyalkylene chain (for example, a polypropylene chain).

Specific examples of the maleic acid-based polymer include a styrene-maleic anhydride copolymer; a maleic anhydride-modified polyalkylene (for example, maleic anhydride-modified polypropylene); a maleic anhydride-graft polymer; and a ternary copolymer such as an ethylene-acrylic acid ester-maleic anhydride copolymer or an ethylene-vinyl acetate-maleic anhydride copolymer.

It is preferable that the equivalent of the functional group that contributes to crosslinking in the crosslinking agent is in the following range. From the viewpoint that nodes and luster are easily reduced in a well-balanced manner, the equivalent of the functional group is preferably 0.1 meq/g or more, 0.2 meq/g or more, 0.3 meq/g or more, 0.4 meq/g or more, 0.45 meq/g or more, 0.48 meq/g or more, 0.5 meq/g or more, 0.6 meq/g or more, 0.7 meq/g or more, 0.8 meq/g or more, 0.9 meq/g or more, 1 meq/g or more, 1.2 meq/g or more, 1.4 meq/g or more, 1.5 meq/g or more, 1.8 meq/g or more, 2 meq/g or more, 2.5 meq/g or more, 3 meq/g or more, or 3.5 meq/g or more. From the viewpoint that nodes and luster are easily reduced in a well-balanced manner, the equivalent of the functional group is preferably 5 meq/g or less, 4 meq/g or less, 3.5 meq/g or less, 3 meq/g or less, 2.5 meq/g or less, 2 meq/g or less, 1.8 meq/g or less, 1.5 meq/g or less, 1.4 meq/g or less, 1.2 meq/g or less, 1 meq/g or less, 0.7 meq/g or less, 0.6 meq/g or less, 0.5 meq/g or less, 0.48 meq/g or less, 0.45 meq/g or less, 0.4 meq/g or less, 0.3 meq/g or less, or 0.2 meq/g or less. From these viewpoints, the equivalent of the functional group is preferably 0.1 to 5 meq/g.

When the crosslinking agent includes the maleic acid-based polymer, the content of the maleic acid-based polymer is preferably 80% by mass or more, 90% by mass or more, 95% by mass or more, 98% by mass or more, or 99% by mass or more, based on the total mass of the crosslinking agent. An embodiment in which the crosslinking agent is substantially composed of the maleic acid-based polymer (substantially 100% by mass of the crosslinking agent is the maleic acid-based polymer) is also acceptable.

It is preferable that the content of the crosslinking agent is in the following range based on the total mass of the fiber for artificial hair. From the viewpoint that nodes and luster are easily reduced in a well-balanced manner, the content of the crosslinking agent is preferably 0.1% by mass or more, 0.3% by mass or more, 0.5% by mass or more, 0.7% by mass or more, or 0.75% by mass or more. From the viewpoint that nodes and luster are easily reduced in a well-balanced manner, the content of the crosslinking agent is preferably 50% by mass or less, less than 50% by mass, 45% by mass or less, 40% by mass or less, 35% by mass or less, 30% by mass or less, 25% by mass or less, 20% by mass or less, 15% by mass or less, 10% by mass or less, 9% by mass or less, 8% by mass or less, or 7.5% by mass or less. From these viewpoints, the content of the crosslinking agent is preferably 0.1% to 50% by mass. From a similar viewpoint, it is preferable that the content of the maleimide-based polymer, the content of the epoxy-modified polymer, or the content of the maleic acid-based polymer are in each of these ranges based on the total mass of the fiber for artificial hair.

The content of the crosslinking agent can be adjusted according to the type of the crosslinking agent, and in consideration of the balance between nodes, luster, and the like, the content of the crosslinking agent may be in the following range based on the total mass of the fiber for artificial hair. The content of the crosslinking agent may be 0.8% by mass or more, 1% by mass or more, 1.5% by mass or more, 1.8% by mass or more, 2% by mass or more, 2.5% by mass or more, 3% by mass or more, 3.5% by mass or more, 4% by mass or more, 4.5% by mass or more, 5% by mass or more, 5.5% by mass or more, 6% by mass or more, 6.5% by mass or more, or 7% by mass or more. The content of the crosslinking agent may be 7% by mass or less, 6.5% by mass or less, 6% by mass or less, 5.5% by mass or less, 5% by mass or less, 4.5% by mass or less, 4% by mass or less, 3.5% by mass or less, 3% by mass or less, 2.5% by mass or less, 2% by mass or less, 1.8% by mass or less, 1.5% by mass or less, 1% by mass or less, 0.8% by mass or less, or 0.75% by mass or less. From a similar viewpoint, the content of the maleimide-based polymer, the content of the epoxy-modified polymer, or the content of the maleic acid-based polymer may be in each of these ranges based on the total mass of the fiber for artificial hair.

It is preferable that the content of the crosslinking agent is in the following range based on the total amount of the polycondensation-based polymer and the crosslinking agent. From the viewpoint that nodes and luster are easily reduced in a well-balanced manner, the content of the crosslinking agent is preferably 0.1% by mass or more, 0.5% by mass or more, or 1% by mass or more. From the viewpoint that nodes and luster are easily reduced in a well-balanced manner, the content of the crosslinking agent is preferably 90% by mass or less, 80% by mass or less, 70% by mass or less, 60% by mass or less, 50% by mass or less, less than 50% by mass, 45% by mass or less, 40% by mass or less, 35% by mass or less, 30% by mass or less, 25% by mass or less, 20% by mass or less, 15% by mass or less, or 10% by mass or less. From these viewpoints, the content of the crosslinking agent is preferably 0.1% to 90% by mass. From a similar viewpoint, it is preferable that the content of the maleimide-based polymer, the content of the epoxy-modified polymer, or the content of the maleic acid-based polymer is in each of these ranges based on the total amount of the polycondensation-based polymer and the crosslinking agent.

The content of the crosslinking agent can be adjusted according to the type of the crosslinking agent, and in consideration of the balance between nodes, luster, and the like, the content of the crosslinking agent may be in the following range based on the total amount of the polycondensation-based polymer and the crosslinking agent. The content of the crosslinking agent may be 1.5% by mass or more, 2% by mass or more, 2.5% by mass or more, 3% by mass or more, 4% by mass or more, 5% by mass or more, 6% by mass or more, 7% by mass or more, 7.5% by mass or more, 8% by mass or more, or 10% by mass or more. The content of the crosslinking agent may be 8% by mass or less, 7.5% by mass or less, 7% by mass or less, 6% by mass or less, 5% by mass or less, 4% by mass or less, 3% by mass or less, 2.5% by mass or less, 2% by mass or less, 1.5% by mass or less, or 1% by mass or less. From a similar viewpoint, the content of the maleimide-based polymer, the content of the epoxy-modified polymer, or the content of the maleic acid-based polymer may be in each of these ranges based on the total amount of the polycondensation-based polymer and the crosslinking agent.

The product XY (X·Y=X×Y) of the proportion X [% by mass] of the content of the crosslinking agent with respect to the total amount of the polycondensation-based polymer and the crosslinking agent and the equivalent Y [meq/g] of the functional group that contributes to crosslinking in the crosslinking agent is preferably in the following range, and when the polycondensation-based polymer is a maleimide-based polymer, the product XY is more preferably in the following range. From the viewpoint that the generation of nodes is easily suppressed, and from the viewpoint that luster is easily reduced, the product XY is preferably 1.8 or more, 1.9 or more, 2 or more, 2.2 or more, 2.3 or more, 2.5 or more, 3 or more, 3.3 or more, 3.5 or more, 4 or more, 4.2 or more, 4.5 or more, or 4.6 or more. From the viewpoint that the generation of nodes is easily suppressed, from the viewpoint that luster is easily reduced, and from the viewpoint that excellent spinnability and processability is easily obtained, the product XY is preferably 10 or less, 8 or less, or 7 or less. From these viewpoints, the product XY is preferably 1.8 to 10, or 2 to 7. The product XY may be 4.65 or more, 4.7 or more, 4.8 or more, 4.9 or more, 5 or more, 6 or more, or 7 or more. The product XY may be 6 or less, 5 or less, 4.9 or less, 4.8 or less, 4.7 or less, 4.65 or less, 4.6 or less, 4.5 or less, 4.2 or less, 4 or less, 3.5 or less, 3.3 or less, 3 or less, 2.5 or less, 2.3 or less, 2.2 or less, 2 or less, 1.9 or less, or 1.8 or less.

The fiber for artificial hair of the present embodiment may contain an additive other than the polycondensation-based polymer and the crosslinking agent. Examples of the additive include a flame retardant, a flame retardant aid, a colorant (a pigment, a dye, or the like), fine particles, a heat-resistant agent, a light stabilizer, a fluorescent agent, an oxidation inhibitor, an antistatic agent, a plasticizer, and a lubricating agent.

The fiber for artificial hair of the present embodiment may contain a flame retardant. From the viewpoint that luster is easily reduced, it is preferable that the flame retardant includes a bromine-based flame retardant (flame retardant containing a bromine atom). The content of the flame retardant is preferably 3 to 30 parts by mass, more preferably 5 to 30 parts by mass, and even more preferably 10 to 28 parts by mass, with respect to 100 parts by mass of the total amount of the polycondensation-based polymer and the crosslinking agent. Furthermore, the content of the flame retardant may be more than 30 parts by mass with respect to 100 parts by mass of the polycondensation-based polymer (for example, a polyamide-based resin).

Examples of the bromine-based flame retardant include a brominated phenol condensation product, a brominated polystyrene resin, a brominated benzyl acrylate-based flame retardant, a brominated epoxy resin, a brominated phenoxy resin (excluding components corresponding to the brominated epoxy resin), a brominated polycarbonate resin, and a bromine-containing triazine-based compound. From the viewpoint that the balance between the drip resistance and processability of the fiber for artificial hair, the transparency of the raw fiber, and the like is excellent, from the viewpoint that nodes are easily reduced, and from the viewpoint that luster is easily reduced, it is preferable that the flame retardant includes a compound having a structure represented by the Formula (1) below (bromine-based flame retardant), and it is more preferable that the flame retardant includes a brominated epoxy resin having a structure represented by the Formula (1) below. When the fiber for artificial hair of the present embodiment contains a compound having a structure represented by Formula (1), from the viewpoint that an enhancement of the dispersibility of the flame retardant can be promoted, it is preferable that the crosslinking agent has an aromatic vinyl compound (for example, styrene) as a monomer unit. As the aromatic vinyl compound, the above-mentioned styrene-based compound and the like in relation to the crosslinking agent can be used.

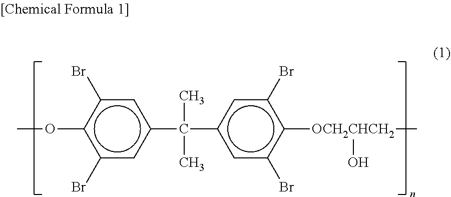

[n represents an integer of 1 or greater.]

A method for producing a fiber for artificial hair of the present embodiment includes a spinning step of spinning a composition containing a polycondensation-based polymer and a crosslinking agent. According to the method for producing a fiber for artificial hair of the present embodiment, the fiber for artificial hair of the present embodiment can be obtained.

In the spinning step, a fiber containing the polycondensation-based polymer and the crosslinking agent can be obtained. In the spinning step, a composition containing the polycondensation-based polymer and the crosslinking agent can be subjected to melt-spinning (melt-deformation). The fiber for artificial hair can be produced by performing melt-spinning by a usual melt-spinning method under appropriate temperature conditions according to the type of the polycondensation-based polymer.

The melt viscosity of the polycondensation-based polymer (for example, a polyamide-based resin) as measured at 300° C. at a shear rate of 2400 [l/s] is preferably in the following range. From the viewpoint that nodes are easily reduced, and from the viewpoint that luster is easily reduced, the melt viscosity of the polycondensation-based polymer is preferably 50 Pa·s or more, more preferably 60 Pa·s or more, even more preferably 70 Pa·s or more, and particularly preferably 75 Pa·s or more. From the viewpoint that excellent spinnability and processability are easily obtained, from the viewpoint that nodes are easily reduced, and from the viewpoint that luster is easily reduced, the melt viscosity of the polycondensation-based polymer is preferably 300 Pa·s or less, more preferably 250 Pa·s or less, even more preferably 200 Pa·s or less, particularly preferably 140 Pa·s or less, extremely preferably 120 Pa·s or less, highly preferably 100 Pa·s or less, and still more preferably 80 Pa·s or less. From these viewpoints, the melt viscosity of the polycondensation-based polymer is preferably 50 to 300 Pa·s.

The method for producing a fiber for artificial hair of the present embodiment may include a mixing step of mixing the polycondensation-based polymer and the crosslinking agent to obtain a composition, before the spinning step. In the mixing step, it is preferable that the melt viscosity of the polycondensation-based polymer is in the above-mentioned range.

The method for producing a fiber for artificial hair of the present embodiment may include a kneading step of melt-kneading a composition containing the polycondensation-based polymer and the crosslinking agent, before the spinning step. As an apparatus for performing melt-kneading, various general kneading machines can be used. Examples of the kneading machine include a single-screw extruder, a twin-screw extruder, a roll, a Banbury mixer, and a kneader, and from the viewpoints of the adjustment of the degree of kneading and the convenience of operation, a twin-screw extruder is preferred.

The method for producing a fiber for artificial hair of the present embodiment may include a stretching step of subjecting the fiber (unstretched fiber) obtained in the spinning step to a stretching treatment, after the spinning step.

From the viewpoint that the strength development of the fiber is likely to occur, the stretch ratio in the stretching step is preferably 1.5 times or more, and more preferably 2.0 times or more. From the viewpoint that fiber breakage is less likely to occur at the time of the stretching treatment, the stretch ratio is preferably 5.0 times or less, and more preferably 4.0 times or less. From these viewpoints, the stretch ratio is preferably 1.5 to 5.0 times, and more preferably 2.0 to 4.0 times.

The stretching treatment may be carried out by a two-step method in which an unstretched fiber is first wound on a bobbin and then stretched in a step that is not continuous with the spinning step, or may be carried out by a direct spinning stretching method in which an unstretched fiber is stretched in a step continuous with the spinning step without being wound on a bobbin. The stretching treatment may be carried out by a one-stage stretching method of performing stretching once to a desired stretch ratio or may be carried out by a multistage stretching method of performing stretching to a desired stretch ratio by two or more times of stretching. By performing such a stretching treatment, a stretched fiber having a finer fiber degree of 100 decitex or less is likely to be obtained, and the tensile strength of the fiber is likely to be enhanced.

The temperature of the stretching treatment is preferably 90° C. to 120° C. When the temperature is 90° C. or higher, the strength of the fiber is likely to be sufficiently secured and fiber breakage is less likely to occur. When the temperature is 120° C. or lower, a suitable tactile sensation of the fiber is likely to be obtained (it is easy to suppress the tactile sensation of the fiber from becoming a plastic-like slippery tactile sensation).

The method for producing a fiber for artificial hair of the present embodiment may include a heat treatment step of heat-treating (annealing) the fiber (stretched fiber) obtained in the stretching step, after the stretching step. By performing the heat treatment step, the thermal shrinkage rate of the stretched fiber can be decreased.

The heat treatment temperature is preferably 150° C. or higher, more preferably 160° C. or higher, even more preferably 170° C. or higher, and particularly preferably 180° C. or higher. The heat treatment temperature is preferably 200° C. or lower. The heat treatment may be carried out continuously after the stretching treatment or may be carried out after a while after winding the stretched fiber once.

A headdress article of the present embodiment includes the fiber for artificial hair of the present embodiment. The headdress article of the present embodiment is an article that is wearable on and removable from the head portion, and the headdress article may be an embodiment composed of the fiber for artificial hair of the present embodiment (for example, a fiber bundle of the fiber for artificial hair). Examples of the headdress article include a hairpiece, a hair wig, and false hair.

### Examples

Hereinafter, the present invention will be specifically described by way of Examples and Comparative Examples; however, the present invention is not intended to be limited to these Examples.

<Production of Unstretched Fiber>

A polycondensation-based polymer was dried to adjust the water absorption rate to 1000 ppm or less. 100 parts by mass of the total amount of the polycondensation-based polymer and a crosslinking agent (crosslinking agent shown in Tables 1 to 3), 27.5 parts by mass of a flame retardant, 2.3 parts by mass of a flame retardant aid, 1.4 parts by mass of a colorant A, 0.6 parts by mass of a colorant B, 0.2 parts by mass of a colorant C, 0.2 parts by mass of an oxidation inhibitor A, 0.2 parts by mass of an oxidation inhibitor B, and 1.1 parts by mass of a lubricating agent were mixed to obtain a mixture. With regard to “100 parts by mass of the total amount of the polycondensation-based polymer and the crosslinking agent”, for example, in Example 1, 92.5 parts by mass of the polycondensation-based polymer and 7.5 parts by mass of the crosslinking agent are used, and in Comparative Example 1, 100 parts by mass of the polycondensation-based polymer is used without using a crosslinking agent. In the tables, the “content (X)” indicates the content of the crosslinking agent based on the total amount of the polycondensation-based polymer and the crosslinking agent, the “equivalent (Y)” indicates the equivalent of a functional group that contributes to crosslinking in the crosslinking agent, and the “product XY” indicates the product of the content (X) and the equivalent (Y).

The details of each of the materials used in Examples and Comparative Examples are as follows. The content of maleic anhydride means the content of a monomer unit of maleic anhydride in the maleimide-based polymer.

(Polycondensation-Based Polymer)

Polyamide-based resin: Polyamide 66, manufactured by Asahi Kasei Corp., trade name “LEONA 1300 301”, melt viscosity 75 Pa·s (measured at 300° C. and a shear rate of 2400 [1/s])

(Crosslinking Agent)

[Maleimide-Based Polymer]

Crosslinking agent A: Styrene-maleimide-maleic anhydride copolymer, manufactured by Denka Company Limited, trade name “MS-L2A”, content of maleic anhydride 6.0% by mass

Crosslinking agent B: Styrene-maleimide-maleic anhydride copolymer, manufactured by Denka Company Limited, trade name “MS-NB”, content of maleic anhydride 1.5% by mass

[Epoxy-Modified Polymer]

Crosslinking agent C: Epoxy-modified acrylic-styrene polymer, manufactured by Toagosei Co., Ltd., trade name “ARUFON UG4070”

Crosslinking agent D: Epoxy-modified acrylic-styrene polymer, manufactured by Toagosei Co., Ltd., trade name “ARUFON UG4035”

Crosslinking agent E: Epoxy-modified acrylic-styrene polymer, manufactured by BASF Japan, Ltd., trade name “Joncryl ADR 4368C”

[Maleic Acid-Based Polymer]

Crosslinking agent F: Maleic anhydride-modified polypropylene, manufactured by Sanyo Chemical Industries, Ltd., trade name “UMEX 1010”

Crosslinking agent G: Maleic anhydride-modified polypropylene, manufactured by Sanyo Chemical Industries, Ltd., trade name “UMEX 1001”

Crosslinking agent H: Maleic anhydride-modified polypropylene, manufactured by RIKEN VITAMIN CO., LTD., trade name “RIKEAID MG-670P”

Crosslinking agent I: Maleic anhydride-modified polypropylene, manufactured by RIKEN VITAMIN CO., LTD., trade name “RIKEAID MG-400P”

Crosslinking agent J: Maleic anhydride-modified polypropylene, manufactured by RIKEN VITAMIN CO., LTD., trade name “RIKEAID MG-250P”

(Other Additives)

Flame retardant: Brominated epoxy resin, manufactured by Sakamoto Yakuhin Kogyo Co., Ltd., trade name “SRT-20000”

Flame retardant aid: Manufactured by Suzuhiro Chemical Co., Ltd., trade name “S-370DE”

Colorant A: Manufactured by Saika Color Co., Ltd., trade name “SPUNDYE NGS BK-35”

Colorant B: Manufactured by Saika Color Co., Ltd., trade name “PA7-4089 RED”

Colorant C: Manufactured by Saika Color Co., Ltd., trade name “PA7-4092 YELLOW”

Oxidation inhibitor A: Manufactured by BASF Japan, Ltd., trade name “IRGANOX 1098”

Oxidation inhibitor B: Manufactured by BASF Japan, Ltd., trade name “IRGAFOS 168”

Lubricating agent: Manufactured by Nitto Chemical Industry Co., Ltd., trade name “CS-8CP”

The above-mentioned mixture was kneaded using a ϕ30-mm twin-screw extruder, and a raw material pellet for spinning was obtained. Next, the raw material pellet was dried to adjust the water absorption rate to 1000 ppm or less. Subsequently, the raw material pellet was melt-kneaded at a barrel setting temperature of 280° C. by using a ϕ40-mm twin-screw extruder. Then, the discharge amount was adjusted to be constant by a gear pump, melt-spinning was then performed in a vertical direction through a die with a hole diameter of 0.5 mm/hole at a temperature of 295° C., and an unstretched fiber (unstretched fiber for artificial hair) was wound at a constant speed by a take-over machine provided at a position 2 m right below the nozzles. The single fiber fineness of the unstretched fiber was 145 decitex.

<Production of Fiber for Evaluation>

An unstretched fiber was stretched at 100° C. and then was subjected to annealing at 180° C., and a fiber for evaluation (fiber for artificial hair after stretching) having a single fiber fineness of 66 decitex was obtained. The stretch ratio was 2.3 times, and the relaxation ratio during annealing was 6.8%. The relaxation ratio during annealing is a value calculated by the formula: “(speed of rotation of a drawing roller during annealing)/(speed of rotation of a feeding roller during annealing)”.

<Evaluation of Fiber for Evaluation>

The number of nodes and the luster were evaluated using the above-mentioned fibers for evaluation. The details of each evaluation are as follows. The measurement results are shown in Tables 1 to 3.

(Number of Nodes)

The number of nodes found in 50 fibers of a 1 m fiber for evaluation was counted. Here, the term “node” is a bump-like portion that bulges outward in a radial direction and is a portion where the maximum diameter of this bump-like portion is 1.2 or more times the minimum diameter in a region extending in the range of ±10 mm in the fiber length direction from the position of the maximum diameter. The numerical value in Tables 1 to 3 is the total number of nodes found in 50 fibers of the fiber for evaluation.

(Luster)

An evaluation of luster was performed by measuring the degree of luster. For the measurement of the degree of luster, a variable angle photometer (goniophotometer) GP-700 manufactured by Murakami Color Research Laboratory was used. First, a reference fiber (manufactured by Denka Company Limited, polyamide-based fiber for artificial hair Luxeena, hue #613T) was placed on a sample stand, the sensitivity adjustment dial value (COARSE) was set to 718, the sensitivity adjustment dial value (FINE) was set to 737, the incident angle was set to 45°, and the intensity of the incident light, the gain of the detector, and the like were adjusted such that the intensity of reflected light at an acceptance angle of 45° was 80% of the detection limit of the apparatus. Thereafter, the above-mentioned fiber for evaluation was placed on a sample stand, and the intensity of reflected light was measured by varying the acceptance angle from 10° to 80°. Then, the maximum value of the intensity of reflected light with respect to the detection limit of the apparatus was obtained as the degree of luster [unit: %]. A smaller value of the degree of luster is more satisfactory.

TABLE 1

| | | | | | | | Comparative |
|---|---|---|---|---|---|---|---|
| | Example 1 | Example 2 | Example 3 | Example 4 | Example 5 | Example 6 | Example 1 |
| Type of | Maleimide-based polymer | | | | | | None |
| crosslinking agent | A | A | A | B | B | B | |
| Content (X) | 7.5 | 5.0 | 2.5 | 2.5 | 5.0 | 10 | — |
| [% by mass] | | | | | | | |
| Equivalent (Y) | 0.66 | 0.66 | 0.66 | 0.19 | 0.19 | 0.19 | — |
| [meq/g] | | | | | | | |
| Product XY | 4.95 | 3.3 | 1.65 | 0.475 | 0.95 | 1.9 | — |
| Number of nodes | 4 | 8 | 55 | 69 | 59 | 15 | 100 |
| Degree of luster | 24 | 26 | 30 | 30 | 29 | 25 | 97 |
| [%] | | | | | | | |

TABLE 2

| | Example 7 | Example 8 | Example 9 | Example 10 | Example 11 | Example 12 |
|---|---|---|---|---|---|---|
| Type of | Epoxy-modified polymer | | | | | |
| crosslinking agent | C | C | D | D | E | E |
| Content (X) | 3.0 | 1.0 | 2.5 | 1.0 | 2.0 | 1.0 |
| [% by mass] | | | | | | |
| Equivalent (Y) | 1.4 | 1.4 | 1.8 | 1.8 | 3.5 | 3.5 |
| [meq/g] | | | | | | |
| Product XY | 4.2 | 1.4 | 4.5 | 1.8 | 7 | 3.5 |
| Number of nodes | 26 | 77 | 18 | 38 | 12 | 27 |
| Degree of luster | 54 | 34 | 37 | 40 | 45 | 38 |
| [%] | | | | | | |

TABLE 3

| | Example 13 | Example 14 | Example 15 | Example 16 | Example 17 | Example 18 | Example 19 | Example 20 | Example 21 |
|---|---|---|---|---|---|---|---|---|---|
| Type of | Maleic acid-based polymer | | | | | | | | |
| crosslinking agent | F | F | G | G | H | I | I | J | J |
| Content (X) | 5.0 | 2.5 | 5.0 | 10 | 10 | 3.0 | 6.0 | 4.0 | 8.0 |
| [% by mass] | | | | | | | | | |
| Equivalent (Y) | 0.93 | 0.93 | 0.46 | 0.46 | 0.38 | 0.73 | 0.73 | 0.50 | 0.50 |
| [meq/g] | | | | | | | | | |
| Product XY | 4.65 | 2.325 | 2.3 | 4.6 | 3.8 | 2.19 | 4.38 | 2 | 4 |
| Number of nodes | 15 | 26 | 21 | 0 | 64 | 49 | 3 | 40 | 51 |
| Degree of luster | 39 | 36 | 37 | 34 | 78 | 54 | 34 | 62 | 68 |
| [%] | | | | | | | | | |

From the results shown in Tables 1 to 3, it is found that in Examples 1 to 21 in which a polycondensation-based polymer and a crosslinking agent were used in combination, the generation of nodes in the fiber is suppressed as compared with Comparative Example 1 in which no crosslinking agent was used. Furthermore, it is found that in Examples 1 to 21, the luster of the fiber is lower than that of Comparative Example 1. Particularly, it is found that when a maleimide copolymer was used as the crosslinking agent (Examples 1 to 6), the luster of the fiber tends to be lower as compared to a case where an epoxy-modified polymer or a maleic acid-based polymer was used as the crosslinking agent (Examples 7 to 21).

1. A fiber for artificial hair, comprising a polycondensation-based polymer and a crosslinking agent.

2. The fiber for artificial hair according to claim 1, wherein a product of a proportion X [% by mass] of a content of the crosslinking agent with respect to a total amount of the polycondensation-based polymer and the crosslinking agent and an equivalent Y [meq/g] of a functional group that contributes to crosslinking in the crosslinking agent is 2 or greater.

3. The fiber for artificial hair according to claim 1, wherein a content of the polycondensation-based polymer is 60% to 90% by mass based on a total mass of the fiber for artificial hair.

4. The fiber for artificial hair according to claim 1, wherein the polycondensation-based polymer includes a polyamide-based resin.

5. The fiber for artificial hair according to claim 1, wherein the crosslinking agent includes a maleimide-based polymer.

6. The fiber for artificial hair according to claim 1, wherein the crosslinking agent includes an epoxy-modified polymer.

7. The fiber for artificial hair according to claim 1, wherein the crosslinking agent includes a maleic acid-based polymer.

8. The fiber for artificial hair according to claim 1,
wherein the fiber further comprises a compound having a structure represented by the Formula (1) below, and
the crosslinking agent has an aromatic vinyl compound as a monomer unit: 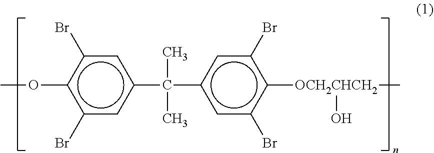
n represents an integer of 1 or greater.

9. A headdress article comprising the fiber for artificial hair according to claim 1.

10. The fiber for artificial hair according to claim 5, wherein a content of a monomer unit of a maleimide compound in the maleimide-based polymer is 35% to 50% by mass based on a total mass of the maleimide-based polymer.

11. The fiber for artificial hair according to claim 5, wherein the maleimide-based copolymer has an aromatic vinyl compound as a monomer unit.

12. The fiber for artificial hair according to claim 5, wherein the maleimide-based copolymer has a styrene-based compound as a monomer unit.

13. The fiber for artificial hair according to claim 5, wherein the maleimide-based copolymer has styrene as a monomer unit.

14. The fiber for artificial hair according to claim 5, wherein the maleimide-based copolymer has an unsaturated dicarboxylic acid anhydride as a monomer unit.

15. The fiber for artificial hair according to claim 1, wherein the crosslinking agent includes an epoxy-modified (meth)acrylic polymer.

16. The fiber for artificial hair according to claim 6, wherein the epoxy-modified polymer has an aromatic vinyl compound as a monomer unit.

17. The fiber for artificial hair according to claim 6, wherein the epoxy-modified polymer has styrene as a monomer unit.

18. The fiber for artificial hair according to claim 1, wherein a content of the crosslinking agent is 4% by mass or more based on a total amount of the polycondensation-based polymer and the crosslinking agent.

19. The fiber for artificial hair according to claim 1, wherein the fiber further comprises a compound having a structure represented by the Formula (1) below: 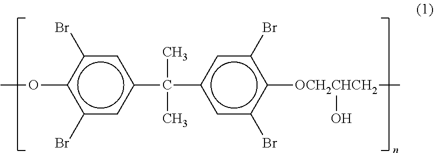
n represents an integer of 1 or greater.

20. The fiber for artificial hair according to claim 1, wherein the fiber does not comprise a polyester.
